(19) United States
(12) Patent Application Publication
(10) Pub. No.: US 2011/0203521 A1
(43) Pub. Date: Aug. 25, 2011

(54) MASKING MATERIAL FOR JIG FOR COATING

(75) Inventors: Masanori Ogawa, Aichi (JP); Makoto Fujii, Aichi (JP); Katsumi Terada, Aichi (JP); Junichi Hasegawa, Aichi (JP)

(73) Assignee: NAGOYA OIL CHEMICAL CO., LTD,, Aichi (JP)

(21) Appl. No.: 12/596,785

(22) PCT Filed: Apr. 25, 2007
(86) PCT No.: PCT/JP2007/058965

§ 371 Date: Oct. 20, 2009

(51) Int. Cl. B05B 15/04

(52) U.S. Cl. 118/504

(57) ABSTRACT

The object of the present invention is to prevent the adhesion of paint to the jig which supports an article to be coated, and to attain the object, the present invention provides a masking member made of a polymer alloy consisting of 20 to 80% by weight of polyphenylene ether and 80 to 20% by weight of polyamide, or a polymer alloy consisting of 100 parts by weight of a polymer mixture into which polyphenylene ether and polyamide are mixed in a weight ratio of between 20:80 and 80:20, and 0 to 50 parts by weight of a styrene group resin and 0 to 50 parts by weight of styrene group elastomer, the article 31 being supported by the jig, and spray coated.

### FIELD OF THE INVENTION

The present invention relates to a masking member for a jig used to support an article to be spray coated during the coating.

### BACKGROUND OF THE INVENTION

When an article to be coated is spray coated, said article is supported by a jig. In a case where said article supported by the jig is spray coated, said spray coating reaches the jig, and paint film adheres to the jig.

### DISCLOSURE OF THE INVENTION

### The Problems to be Solved by the Invention

An article to be coated is supported by a jig made of iron or the like, and then spray coated with the prescribed color of paint.

The resulting coated article is then introduced to a drying oven together with the jig, and after drying and curing, said article is then taken out of the drying oven, and is detached from the jig, after which the next article is supported by the jig for the coating-drying process. After said coating-drying process is repeated a few times, it is feared that the paint film adhering to said jig will come off and scatter around the jig, or that the paint film adhering to said jig will become thick, making it difficult for said article to be supported in the correct position. In this case, film pieces coming off and scattering around said jig will adhere to said article during spray coating, resulting in said article's poor appearance, and in a case where said article is not supported fast in the correct position, said article may be coated unevenly.

To solve the above described problem, after repeating the coating-drying process in the prescribed number of times, it is necessary to wash the jig. However, washing the jig to remove the coating film adhering to the jig is very troublesome and seriously hampers the process of mass and continuous production.

### Means to Solve Said Problems

As means to solve the problems, the present invention provides masking members 20, 28 to protect a jig 1 which supports an article 31 to be spray coated, made of a polymer alloy consisting of 20 to 80% by weight of polyphenylene ether, and 80 to 20% by weight of polyamide, wherein said masking members 20, 28 cover the area of said jig 1 to which the spray coating is affected, and further the present invention provides masking members 20, 28 to protect a jig 1 which supports an article 31 to be spray coated, made of a polymer alloy consisting of 100 parts by weight of a polymer mixture into which polyphenylene ether and polyamide are mixed in a weight ratio between of 20:80 and 80:20, and 0 to 50 parts by weight of styrene group resin and 0 to 50 parts by weight of a styrene group elastomer, wherein said masking members 20,28 cover the area of said jig 1 to which said spray coating is affected.

The present invention is useful for mass production articles 31 which need to be coated such as car bumpers.

### EFFECT OF THE INVENTION

### [Action]

The area of said jig 1 that will be affected by spray coating is covered with said masking members 20, 28, after which the article 31 to be coated is attached to said jig 1, and said article 31 is then spray coated.

During the spray coating of said article 31, the coating is performed by the adhering of paint (P) mist to said article, said paint (P) mist reaching the backside of said article 31.

Said paint mist, however adheres to said masking members 20 and 28, mostly missing said jig 1.

Said masking members 20 and 28 of claim 1 are made of a polymer alloy consisting of 20 to 80% by weight of polyphenylene ether (PPE) and 80 to 20% by weight of polyamide(PA). In said polymer alloy, PA is a component to improve the moldability of PPE, and in a case where said polymer alloy contains PA in an amount of less than 20% by weight, the resulting polymer alloy has poor flexibility, making the deep draw molding of said polymer alloy impossible, and further the adhesion of paint (P) film to the surface of said masking member degrades, so that said paint film may peel off the surface of said masking member during handling or coating, said peeling paint film breaking to pieces, which scatter to contaminate the surrounding area.

In a case where said polymer alloy contains PA in an amount of beyond 80% by weight, the resulting polymer alloy has high water absorption, resulting in the poor dimensional stability of the molded masking member.

Said masking members 20 and 28 20A of claim 2 are made of a polymer alloy consisting of 100 weight parts of a mixture into which PPE and PA are mixed in an weight ratio of between 20:80 and 80:20, and 0 to 50 parts by weight of a styrene group resin and 0 to 50 parts by weight of a styrene group elastomer. Said styrene group resin gives said polymer alloy rigidity and improves the moldability of said polymer alloy. To demonstrate said effect of said styrene group resin clearly, said styrene group resin is preferably added to said polymer alloy in an amount of more than 2 parts by weight, but in a case where said styrene group resin is added to said polymer alloy in an amount of beyond 50 parts by weight, the resulting molded masking member has poor heat resistance. Said styrene group elastomer gives said polymer alloy good elasticity, improving its deep drawing moldability. To demonstrate said effect clearly, said styrene group elastomer is preferably added to said polymer alloy in an amount of more than 2 parts by weight, but in a case where said styrene group elastomer is added to said polymer alloy in an amount of beyond 50 parts by weight, the resulting molded masking member has excessive flexibility, resulting in poor shape maintaining property.

For heat resistance and rigidity, the total amount of PPE and PA is desirably set to be more than 40% by weight.

### [Effect]

According to the present invention, the adhesion of paint to said jig used to support said article to be spray coated is certainly prevented, and the time and labor of washing said jig can be avoided.

### BRIEF DESCRIPTION OF THE DRAWINGS

FIGS. 1 to 10 relate to an embodiment of the present invention.

FIG. 1: Perspective view of said jig.

FIG. 2: Plan view of said jig.

FIG. 3: Side view to illustrate said jig.

A: the regular position.

B: the oblique upward position.

C: the oblique downward position.

FIG. 4: Illustration for a situation wherein the pivot frame of said jig is locked into regular position.

FIG. 5: Illustration for a situation wherein the locking of the pivot frame of said jig is released in the regular position.

FIG. 6: Perspective view of dismantled masking member (for the fixing frame)

FIG. 7: Perspective view to illustrate a situation wherein said masking member (for the fixing frame) is attached to said jig.

FIG. 8: Perspective view to illustrate a situation wherein said masking members (for the fixing frame and the pivotable frame) are attached to said jig.

FIG. 9: Perspective view to illustrate a situation wherein a bumper is attached to said jig.

FIG. 10: Perspective view to illustrate a situation wherein said bumper is coated.

FIGS. 11 and 12 relate to another embodiment of the present invention

FIG. 11: Perspective view to illustrate a jig and masking member.

FIG. 12: Perspective view to illustrate a situation wherein said bumper is coated.

### EXPLANATION OF CODE

1, 1A: Jig

7: Fixing frame

12: Pivot frame

20, 28, 20A: Masking member

31: Bumper (Article to be coated).

### BEST MODE TO PRACTICE THE INVENTION

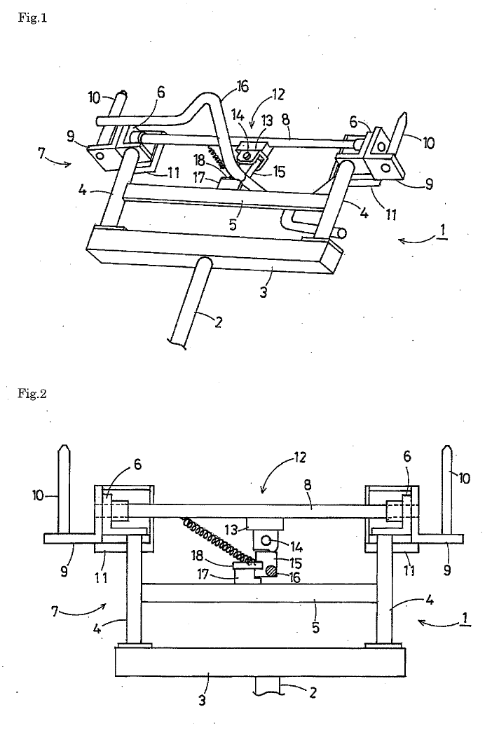

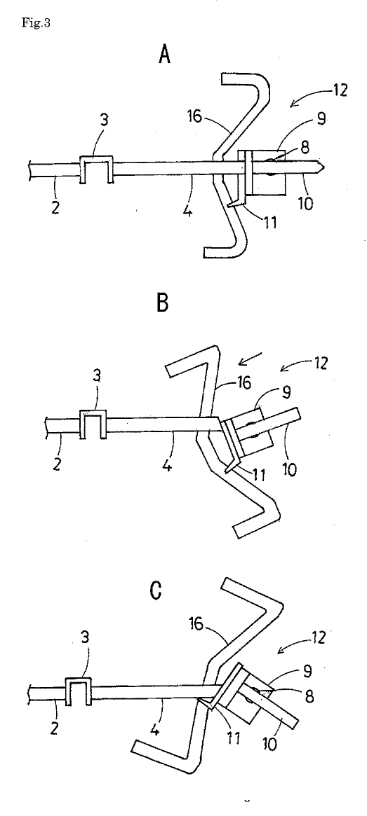

The present invention is illustrated by an embodiment shown in FIGS. 1 to 10.

FIG. 1 shows a jigl used in the coating process, said jig 1 consisting of a supporting post 2, a cross beam 3 attached at the end of said supporting post 2, a pair of side beams 4,4 extending from both ends of said cross beam 3, a middle cross beam 5 connecting to both side beams 4,4 at the middle of each side beam 4, a fixing frame 7 consisting of a pair of L-shaped bearing brackets 6,6, each L-shaped bearing bracket 6 being attached to the ends of each side beam 4, a rotary shaft 8 both ends of which are rotatably supported by said L-shaped bearing brackets 6,6, a pair of L-shaped rotatable brackets 9,9 fixed to both ends of said rotary shaft 8 on the outside of said L-shaped bearing brackets 6,6, a pair of fitting bars 10,10 projecting from said L-shaped rotatable brackets 9,9, and a pivotable frame 12 consisting of a pair of square shaped rotation control frames 11,11, both square shaped rotation control frames 11, 11 being held out from the inside of said L-shaped rotatable brackets 9, 9.

A U-shaped bearing 13 is fixed to the backside of said rotary shaft 8 at the middle section of said rotary shaft 8, and a pivot member 15 is pivotally supported on the axis 14 of said U⁻shaped bearing 13, and a handle 16 is supported by said pivot member 15.

A worker grips said handle 16 by hand so as to move said pivotable frame 12 oscillating it from the regular position as shown in FIG. 3. A to the oblique upward position as shown in FIG. 3B, and further to the oblique downward position as shown in FIG. 3C, and the pivoting movement of said pivotable frame 12 is regulated by the attachment of the lower edges of said square shaped rotation control frames 11, 11 of said pivotable frame 12 to said side beams 4,4 in the oblique downward position of said pivotable frame 12, as shown in FIG. 3C.

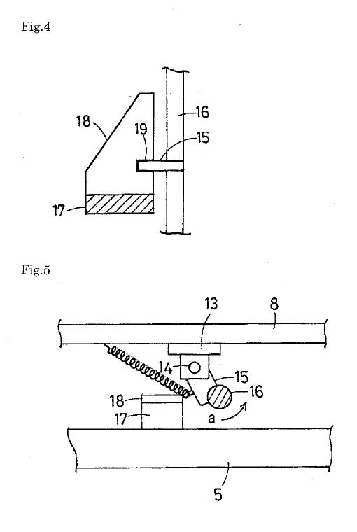

A base 17 extends from the center of said middle cross beam 5, a stand piece 18 protrudes from said base 17, and in the regular position of said pivotal frame 12 as shown FIG. 3C, the pivot member 15 of said handle 16 engages with the notched part 19 of said stand piece 18 to lock the pivotal movement of said pivotable frame 12 as shown in FIG. 4, and in a case where said pivotable frame 12 is pivotably moved to the positions shown in FIG. 3B or C, said handle 16 is moved in a crosswise direction as shown by arrow a in FIG. 5 so as to release said pivot member 15 from the notched part 19 of said stand piece 18, and thus the lock of said pivotable frame 12 is released.

A masking member 20 to protect said fixing frame 7 from coating is shown in FIG. 6. Said masking member 20 has a box shape and consists of an upper side masking part 21 and an underside masking part 22, and a supporting post hole 23 is formed in the rear edge of said upper side masking part 21, and a plural number of insert slits 25 are formed in both sides of said upper side masking part 21, and a plural number of insert pieces 24 standing out from both sides of said underside masking part 22 are respectively inserted into said insert slits 25. Recessed 26, 27 parts are formed in the front edges of said upper side and underside masking parts 21, 22 to avoid interference of the front edges of said upper side and under side masking parts 21, 22 with said handle 16.

Said masking member 20 is made of a polymer alloy consisting of 20 to 80% by weight of PPE and 80 to 20% by weight of PA, or a polymer alloy consisting of 100 parts by weight of a mixture into which PPE and PA are mixed in an weight ratio of between 20:80 and 80:20, and 0 to 50 parts by weight of a styrene group resin, and 0 to 50 parts by weight of a styrene group elastomer.

Wherein PPE is poly (2,6-dimethylphenylene ether) produced by the polymerization of 2,6-xylenol by an oxidative coupling reaction using a copper-amine catalyst. Said PPE may include modified PPE with styrene or a styrene group resin.

Further, PA is synthesized by the ring opening polymerization of lactam (polyamide 6), polycondensation of amino-carboxylic acid, polycondensation of diamine and dibasic acid (polyamide 66) and the like, and further, PA may include polyamide 3, 4, 46, 11, 12, and the like.

Said styrene group resin includes polystyrene, styrene-acrylonitride copolymer, styrene-acrylonitrile-butadiene copolymer, styrene-butadiene copolymer, styrene-moleic acid copolymer and the like.

Said styrene group elastomer has polystyrene block as its hard segment and conjugated diene polymer block as its soft segment, and said styrene group elastomer shows a vulcanized rubber like property at a low temperature, and melts by heating, showing fluidity in a hot situation.

Said styrene group elastomer includes such as styrene-butadien-styrene block copolymer (SBS), styrene-isoprene-styrene block copolymer (SIS), styrene-ethylene/butylene-styrene block copolymer (SEBS), styrene-ethylene/propylene-styrene block copolymer (SEPS), partially hydrogenated styrene-ethylene/butylene-styrene block copolymer (partially hydrogenated SEBS), styrene, (ethylene-ethylene/propylene)-styrene block copolymer (SEEPS) and the like.

Said polymer alloy may include an inorganic filler such as calcium carbonate, magnesium carbonate, barium sulphate, calcium sulphate, calcium sulphite, calcium phosphate, calcium hydroxide, magnesium hydroxide, aluminium hydroxide, magnesium oxide, titanium oxide, iron oxide, zinc oxide, alumina, silica, diatomaceous earth, dolomite, gypsum, talc, clay, asbestos, mica, glass fiber, carbon fiber, calcium silicate, bentonite, white carbon, carbon black, iron powder, aluminium powder, stone powder, blast furnace slag, fly ash, cement, zirconia powder, and the like; a natural fiber such as cotton, hemp, bamboo fiber, palm fiber, wool, silk, and the like; an organic synthetic fiber such as polyamide fiber, polyester fiber, acrylic fiber, viscose fiber, acetate fiber, vinyl chloride fiber, vinylidene chloride fiber, vinylon fiber, acetate fiber, and the like; an inorganic fiber such as asbestos fiber, glass fiber, carbon fiber, ceramic fiber, metal fiber, whisker, and the like; an organic filler such as, linter, linen, sisal, wood flour, coconut shell flour, walnut powder, starch, wheat flour, and the like. Such reinforcement as aforementioned may be added to said polymer alloy to improve its shape maintaining property, dimensional stability, compressive and tensile strength, and the like. Said filler is commonly added to said polymer alloy in an amount of less than 5% by weight.

Further a pigment; dye; plasticizer such as dibutyl phthalate (DBP), dioctyl phthalate (DOP), and the like; antioxidant; antistatic agent; crystallizer; fire retardant; flameproof agent; insecticide; preservative; wax; lubricant; antioxidant; ultraviolet absorber; a foaming agent such as chemical foaming agent, capsule type foaming agent, and the like, may be added to said polymer alloy. Said ingredient may be singly added to said polymer alloy or two or more kinds of said ingredients may be added to said polymer alloy.

Said masking member is manufactured by cutting or folding a sheet into a predetermined shape, or by the vacuum forming, pressure forming, vacuum-pressure forming, blow molding, press molding and the like, said vacuum forming and vacuum-pressure forming being the preferable manufacturing methods for easiness of mass-production.

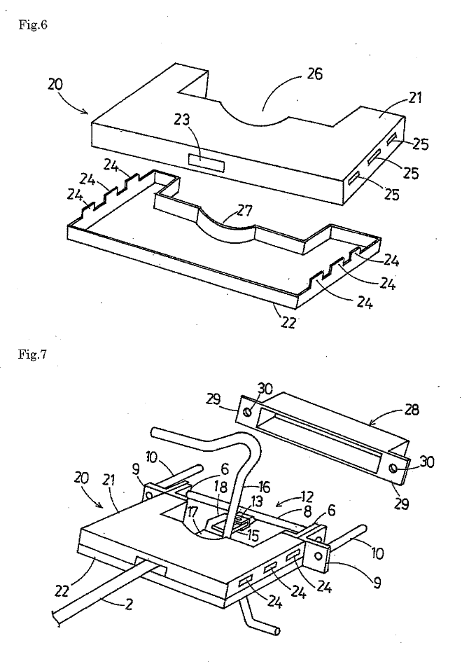

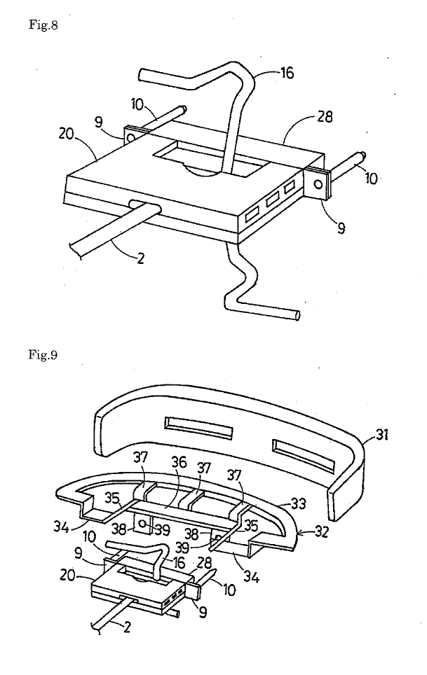

As shown in FIG. 7, the upper side and underside of said fixing frame 7 of said jig 1 are both covered with said upper side masking part 21 and underside masking part 22, and the insert pieces 24 of said underside masking part 22 are each inserted into said insert slits 25 of said upper side masking part 21, fixing said upper side masking part 21 and said underside masking part 22, to construct said masking member 20.

Further, as shown FIG. 7, said pivotable frame 12 is covered with a rectangular box shaped masking member 28, which is used to protect said pivotable frame 12 from coating.

Said masking member 28 is equipped with a pair of brackets 29, 29, each bracket 29 having a insert hole 30 into which said fitting bar 10 is inserted, and said masking member 28 is attached to said pivotable frame 12 by inserting said fitting bars 10, 10 of said pivotable frame 12 into said holes 30, 30 of said brackets 29, 29 respectively as shown in FIG. 8.

Said masking member 28 is manufactured by the same method as said masking member 20 using the same materials as used in said masking member 20.

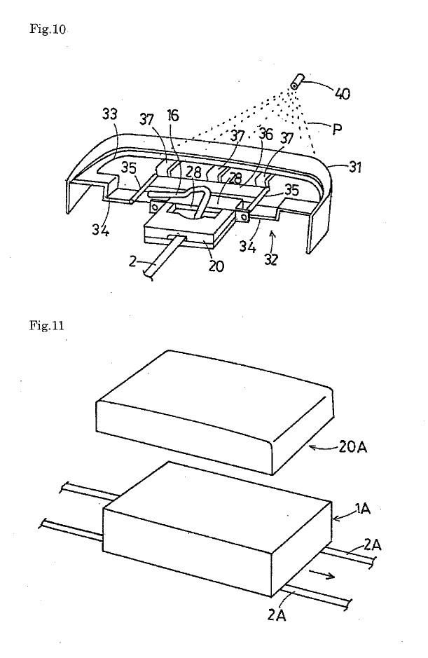

In this embodiment, the bumper 31 of a car is selected as the article to be coated, as shown in FIG. 9, and when said bumper 31 is supported by said jig 1, first a bumper jig 32 is attached to said bumper 31. Said bumper attaching jig 32 consists of a front edge part 33 having an arch shape corresponding to arch shape of said bumper 31, a rear edge part 34, 34 projecting crosswise from both sides of said arch shaped front edge part 33, a pair of bars 35, 35 projecting forward from the end of each rear edge part 34, a beam 36 connecting to both bars 35, 35, a plural number of arms 37 each connecting to said beam 36 and said front edge part 33, and a pair of brackets 38, 38 hanging from the rear edge of said beam 36. Insert holes 39, 39, into which said fitting bars 10, 10 of said jig 1, are each to be inserted, are formed in said brackets 38, 38.

Said bumper jig 32 is attached to the front side of said jig 1 by inserting each of said fitting bars 10, 10 of said jig 1 into said insert holes 39, 39 of said brackets 38, 38 of said bumper jig 32, and said bumper 31 is supported by the front edge part 33 of said bumper jig 32 as shown in FIG. 10.

As described above, said bumper 31 is supported by said bumper jig 32 while paint P is sprayed onto said bumper 31 with a spray gun 40. When said bumper 31 is spray coated, the paint mist from said spray gun reaches behind said bumper 31, but since said jig 1 is protected by said masking member 20, 28, said jig 1 is protected from contamination by paint.

During said coating process, a worker grips said handle 16 to pivotally move said pivotable frame 12 up and down so that the paint wholly reaches said bumper 31.

After the above described coating, said coated bumper 31 is introduced into the curing process together with said jig 1 and said bumper jig 32, as paint adheres to said masking members 20, 28. Nevertheless, since said masking members 20, 28 are made of said polymer alloy having an affinity with the paint, the surfaces of said masking members 20, 28 also have an affinity with the paint film so that the paint film is hard to peel from the surface of said masking members 20, 28, said paint film firmly adhering to the surface of said masking members 20, 28 without the paint film pieces having been scattered around said masking members 20, 28.

Said masking members 20, 28 may be used in the next coating process without removing said paint film.

After said coating process is repeated a predetermined times, said masking members 20, 28 are replaced with new masking members, and said used masking members to which paint has adhered may be incinerated, or recycled by such as smashing them into plastic material.

Besides the above described embodiment, said masking member of the present invention is applied to protect jigs and to support many kinds of articles to be coated, for example, cabinets or parts of office machines such as copy machines, printers and the like, cabinet or parts of house-hold electrical appliances such as televisions, microwave ovens and the like.

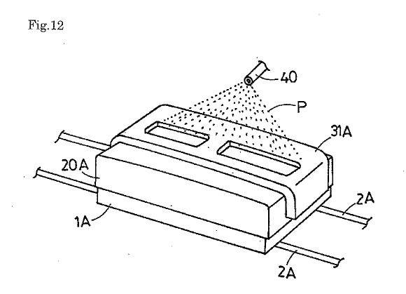

FIGS. 11 and 12 relate to another embodiment. In this embodiment, a moving stand jig 1A moving on a pair of rails 2A, 2A is used. A box t_{yp}e masking member 20A covers said moving stand jig 1A, and the article to be coated, such as a bumper 31A or the like, is placed on said jig 1A, as shown in FIG. 12.

Said masking member 20A is made of a polymer alloy the same as in the former embodiment. Said moving stand jig 1A, which said masking member 20A covers, and on which said bumper 31A is placed, is transported to a coating point, and, then said bumper 31A is coated with paint P by spray coating, using a spray gun 40.

### POSSIBILITY OF INDUSTRIAL UTILITY

By using said masking member of the present invention, the adhering of paint to said jig is prevented, so that even in a case of multi color coating, said jig can be used repeatedly, and the coating process in mass continuous production can be performed without obstacles.

1. (canceled)

2. A masking member to protect a jig which supports an article to be spray coated, made of a polymer alloy consisting of 100 parts by weight of a polymer mixture into which polyphenylene ether and polyamide are mixed in a weight ratio of between 20:80 and 80:20, and 2 to 50 parts by weight of a styrene group resin and 2 to 50 parts by weight of a styrene group elastomer, wherein said masking member covers the area of said jig to which said spray coating is affected.

3. A masking member to protect a jig which supports an article to be spray coated in accordance with claim 2, wherein the total amount of polypheylene ether and polyamide in said polymer alloy is more than 40% by mass.

4. A masking member to protect a jig which supports an article to be spray coated in accordance with claim 3, wherein said article to be spray coated is the bumper of a car.

5. A masking member to protect a jig which supports an article to be spray coated in accordance with claim 2, wherein said article to be spray coated is the bumper of a car.
